(19) United States
(12) Patent Application Publication
(10) Pub. No.: US 2019/0348805 A1
(43) Pub. Date: Nov. 14, 2019

(54) STRUCTURE FOR MUTUALLY EXCLUSIVE USE OF CONNECTORS

(71) Applicant: SHARP KABUSHIKI KAISHA, Sakai City (JP)

(72) Inventor: SEIYA SHIOZAKI, Sakai City (JP)

(21) Appl. No.: 16/404,676

(22) Filed: May 6, 2019

(30) Foreign Application Priority Data
May 11, 2018 (JP) 2018-092258

(51) Int. Cl. H01R 27/00

(52) U.S. Cl. CPC H01R 27/00

(57) ABSTRACT

A structure for mutually exclusive use of connectors includes plural connectors. The plural connectors are disposed adjacent to each other on an outer surface of a housing of an electronic device. Each of the plural connectors has a connecting portion connectable to an external device. The plural connectors are located on radial lines starting from a predetermined point and the connecting portion of each of the plural connectors faces the predetermined point, so that an external device is connectable only to a selected one of the plural connectors.

### BACKGROUND

### 1. Field

The present disclosure relates to a structure for mutually exclusive use of connectors.

### 2. Description of the Related Art

Regarding external interface connectors (hereinafter simply called connectors), such as universal serial bus (USB) connectors, provided in an electronic device, such as an image forming device or a personal computer, new products are being rapidly and extensively developed. Changing of the type (shape) of connector is not unusual, though such a newly developed connector has backward compatibility. In a transition period from one type of connector (older one) to another (newer one), it is desirable to support both types of connectors to satisfy user needs.

In a typical electronic device including an older type and a newer type of connectors, a controller is provided for each connector to perform electrical control so that only a selected one of the connectors can be used. (first configuration of the related art).

Japanese Unexamined Patent Application Publication No. 2001-351736 discloses a connector device including two connectors formed in different shapes and a slidable door. The two connectors are disposed adjacent to each other. As a result of covering one connector with the door, only the other connector can be used (second configuration of the related art).

Japanese Unexamined Patent Application Publication No. 2017-138697 discloses an electronic device including two connectors formed in different shapes. The two connectors are disposed closely to each other or are joined with each other. With this configuration, when an external device is connected to one connector, it is not physically possible to connect another external device to the other connector (third configuration or the related art).

### SUMMARY

The first configuration of the related art requires a controller integrated circuit (IC) for each connector, thereby increasing the cost.

The second configuration of the related art requires a slidable door, which also increases the cost and may cause a breakage in the door.

The third configuration of the related art increases the designing and manufacturing cost. Additionally, it may not be possible to dispose two connectors closely to each other due to the interference of the frames of the connectors, and connectors used in the third configuration are restricted to those configured in a shape that can be disposed closely to each other. The fixing strength of the connectors is also decreased.

It is thus desirable to provide a structure for mutually exclusive use of connectors that can be produced easily and inexpensively.

According to an aspect of the disclosure, there is provided a structure for mutually exclusive use of connectors. The structure includes plural connectors that are disposed adjacent to each other on an outer surface of a housing of an electronic device. Each of the plural connectors has a connecting portion which is connectable to an external device. The plural connectors are located on radial lines starting from a predetermined point and the connecting portion of each of the plural connectors faces the predetermined point, so that an external device is connectable only to a selected one of the plural connectors.

In the present disclosure, a connector provided in an electronic device (host) refers to a receptacle, and a connector of an external device to be connected to the connector (receptacle) of the electronic device refers to a plug.

### BRIEF DESCRIPTION OF THE DRAWINGS

FIGS. 1A and 1B are respectively a front view and a planar sectional view of a structure for implementing the mutually exclusive use of connectors according to a first aspect of a first embodiment;

FIG. 2 is a schematic view illustrating a state in which plural USB connectors and a USB controller are connected to each other via a connecting line in an electronic device (host) including the structure shown in FIGS. 1A and 1B according to the first aspect of the first embodiment;

FIG. 3 is a schematic view illustrating a state in which plural USB connectors and a USB controller are connected to each other via a bus switch by using a signal line according to a first modified example of the first aspect of the first embodiment;

FIG. 4 is a schematic view illustrating a state in which plural USB connectors and an Ethernet controller are connected to each other by using signal lines according to a second modified example of the first aspect of the first embodiment;

FIG. 5 is a schematic view illustrating a state in which plural connectors and a power supply control IC are connected to each other by using a signal line according to a third modified example of the first aspect of the first embodiment;

FIG. 6 is a planar sectional view of a structure for implementing the mutually exclusive use of connectors according to a second aspect of the first embodiment;

FIG. 7 is a planar sectional view of a structure for implementing the mutual exclusive use of connectors according to a third aspect of the first embodiment;

FIG. 8 is a side sectional view of a structure for implementing the mutually exclusive use of connectors according to a fourth aspect of the first embodiment;

FIG. 9 is a side sectional view of a structure for implementing the mutually exclusive use of connectors according to a modified example of the fourth aspect of the first embodiment;

FIGS. 10A and 10B are respectively a front view and a planar sectional view of a structure for implementing the mutually exclusive use of connectors according to a first aspect of a second embodiment;

FIG. 11 is a schematic view illustrating a state in which plural USB connectors and a USB controller are connected to each other via a connecting line according to the first aspect of the second embodiment;

FIG. 12 is a side sectional view of a structure for implementing the mutually exclusive use of connectors according to a second aspect of the second embodiment;

FIGS. 13A and 13B are respectively a front view and a side sectional view of a structure for implementing the mutually exclusive use of connectors according to a third embodiment;

FIG. 14 is a planar sectional view of a structure for implementing the mutually exclusive use of connectors according to a fourth embodiment;

FIG. 15 is a planar sectional view of a structure for implementing the mutually exclusive use of connectors according to a fifth embodiment; and

FIGS. 16A and 16B are respectively a front view and a side sectional view of a structure for implementing the mutually exclusive use of connectors according to a sixth embodiment.

### DESCRIPTION OF THE EMBODIMENTS

### First Aspect of First Embodiment

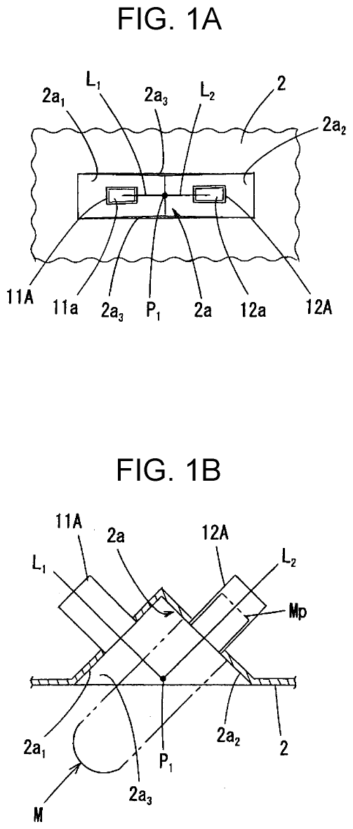

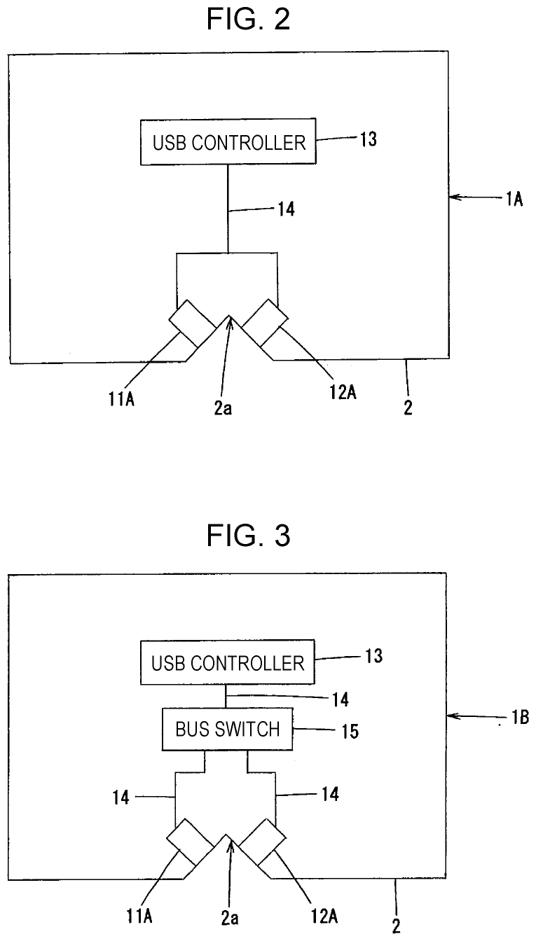

FIGS. 1A and 1B are respectively a front view and a planar sectional view of a structure for implementing the mutually exclusive use of connectors according to a first aspect of a first embodiment. FIG. 2 is a schematic view illustrating a state in which plural USB connectors and a USB controller are connected to each other via a connecting line in an electronic device (host) including the structure shown in FIGS. 1A and 1B according to the first aspect of the first embodiment.

As shown in FIGS. 1A through 2, the structure includes two connectors arranged side by side on an outer surface 2 of a housing of an electronic device 1A.

In the first aspect of the first embodiment, as plural connectors, a Type-A USB connector 11A and a Type-C USB connector 12A are disposed at a horizontally elongated hollow surface portion 2a provided at part of the outer surface (side surface) 2 of the electronic device (host) 1A. In FIGS. 1A and 1B, the USB connectors 11A and 12A are shown in a simplified form.

Examples of the electronic device 1A, which serves as a host, are image forming devices, personal computers, mobile terminals such as smartphones and tablets, televisions sets, recorders, audio devices, and white goods supporting Internet of things (IoT). Within the electronic device 1A, a USB controller (controller IC) 13 and a connecting line 14 are disposed. The connecting line 14 branches off from the USB controller 13 and is electrically connected to the USB connectors 11A and 12A. The connecting line 14 includes signal lines and power supply lines.

In the structure of the first aspect of the first embodiment, connecting portions 11a and 12a of the two USB connectors 11A and 12A are located at the same position as the hollow surface portion 2a of the outer surface 2 of the electronic device 1A.

More specifically, the hollow surface portion 2a has two planes 2a₁ and 2a₂ which join each other at a right angle and a pair of upper and lower opposing planes 2a₃ formed in an isosceles triangle. The opposing planes 2a₃ connect the two planes 2a₁ and 2a₂ and the outer surface 2. The connecting portions 11a and 12a of the two USB connectors 11A and 12A are located on the two planes 2a₁ and 2a₂ . That is, the positions of the connecting portions 11a and 12a coincide with those of the planes 2a₁ and 2a₂.

The two planes 2a₁ and 2a₂ are perpendicular to the horizontal direction and have slots through which the connecting portions 11a and 12a of the USB connectors 11A and 12A are exposed outside.

FIG. 1B shows a state in which the connecting portions 11a and 12a of the USB connectors 11A and 12A are inserted into and fixed at the slots of the planes 2a₁ and 2a₂. In actuality, however, holders for holding the USB connectors 11A and 12A, for example, are fixed around the slots so as to stop the USB connectors 11A and 12A from coming out of the slots during the use.

In the structure according to the first aspect of the first embodiment, the two USB connectors 11A and 12A are respectively located on radial lines L₁ and L₂ starting from a predetermined point P₁, and also, the connecting portions 11a and 12a of the USB connectors 11A and 12A face the predetermined point P₁.

In the structure configured as described above, an external device can be connected only to a selected one of the USB connectors 11A and 12A.

That is, as shown in FIG. 1B, when a connector (plug) Mp of a USB memory M as an external device is connected to the USB connector 12A, which serves as a receptacle, it is not physically possible to connect another external device to the USB connector 11A because the connection path to the USB connector 11A is blocked. When an external device is connected to the USB connector 11A, it is not physically possible to connect another external device to the USB connector 12A because the connection path to the USB connector 12A is blocked.

The structure according to the first aspect of the first embodiment does not need additional components and achieves cost reduction. The plural connectors can be disposed with a certain distance therebetween under the normal condition of use, instead of being disposed too closely to interfere with each other. Thus, the machining cost for forming connectors in a special shape does not incur, and fixing strength of connectors is not decreased.

Additionally, it is possible to connect an external device mutually exclusively to one of plural connectors having the same interface but being formed in different shapes. Without using a controller IC for each connector or a device (bus switch) for connecting a signal line to plural connectors, a signal line branches off from one controller IC and is safely connected to plural connectors without causing a signal collision. Only the single controller IC is sufficient, thereby achieving a cost reduction.

In FIGS. 1A and 1B, the hollow surface portion 2a is formed in the housing of the electronic device 1A by way of example. Alternatively, the hollow surface portion 2a may separately be formed as a different component, and a unit body in which the two USB connectors 11A and 12A are fixed at the hollow surface portion 2a may be inserted into a mounting hole formed in the housing of the electronic device 1A.

### First Modified Example of First Aspect of First Embodiment

FIG. 3 is a schematic view illustrating a state in which the plural connectors and the USB controller of the first embodiment are connected to each other via a bus switch by using a signal line according to a first modified example of the first aspect of the first embodiment. In FIG. 3, elements similar to those in FIG. 2 are designated by like reference numerals.

The structure according to the first aspect of the first embodiment is also applicable to an electronic device 1B of the first modified example shown in FIG. 3.

The electronic device 1B includes a USB controller 13, a bus switch 15, two USB connectors 11A and 12A, and a hollow surface portion 2a. The bus switch 15 is electrically connected to the USB controller 13 via a signal line 14. The USB connectors 11A and 12A are electrically connected to the bus switch 15 via signal lines 14. The hollow surface portion 2a is provided on an outer surface 2 of the electronic device 1B and holds the USB connectors 11A and 12A.

In the electronic device 1B, as well as in the electronic device 1A, an external device, such as a USB memory or a USB cable, can be connected only to a selected one of the USB connectors 11A and 12A.

Without using plural controllers as in the first configuration of the related art, only one controller may be used and be connected to plural connectors as a result of a signal line branching off from a bus switch, as in the second configuration of the related art. In this case, however, when a user connects plural external devices to individual connectors, only one connector functions, and the user may be confused about this situation.

In the structure according to the first modified example of the first aspect of the first embodiment, only one connector can physically be used so as to address the above-described issue.

### Second Modified Example of First Aspect of First Embodiment

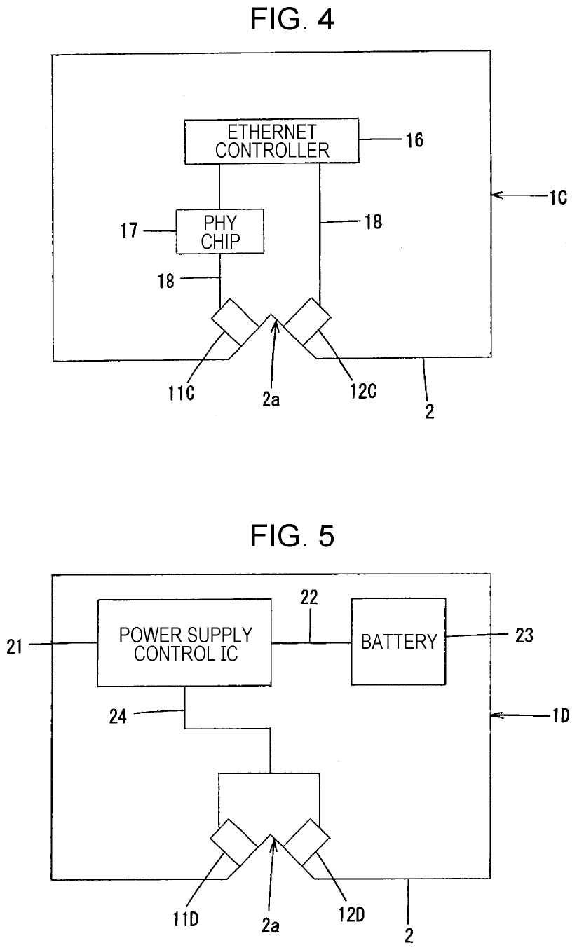

FIG. 4 is a schematic view illustrating a state in which plural connectors and an Ethernet controller are connected to each other by using signal lines according to a second modified example of the first aspect of the first embodiment. In FIG. 4, elements similar to those in FIG. 2 are designated by like reference numerals.

The structure according to the first aspect of the first embodiment is also applicable to an electronic device 1C of the second modified example show in FIG. 4.

The electronic device 1C includes an Ethernet controller 16, a physical layer (PHY) chip 17, a wired local area network (LAN) connector 11C, a wireless LAN connector 12C, and a hollow surface portion. 2a. The wired LAN connector 11C is electrically connected to the Ethernet controller 16 via the PHY chip 17 by using a signal line 18. The wireless LAN connector 12C is electrically connected to the Ethernet controller 16 by using a signal line 16. The hollow surface portion 2a is provided on an outer surface 2 of the electronic device 1C and holds the wired LAN connector 11C and the wireless LAN connector 12C.

In the electronic device 10, as well as in the electronic devices 1A and 1B, an external device, such as a wired LAN cable or a wireless LAN dongle, which is not shown, can be connected only to a selected one of the wired LAN connector 11C and the wireless LAN connector 12C.

According to the second modified example, even with the use of connectors having different interfaces, such as a wired. LAN connector and a wireless LAN connector, the mutually exclusive use of multiple functions is implemented.

In an electronic device having a wired LAN connector and a wireless LAN connector, if a wired LAN cable is connected to the wired LAN connector and a wireless LAN dongle is connected to the wireless LAN connector at the same time, a single Ethernet controller (that with only one Internet protocol (IP) address) is required to perform software control to determine which one of the wired. LAN connector and the wireless LAN connector will be used.

In the structure according to the second modified example of the first aspect of the first embodiment, only one connector can physically be used, thereby making the above-described software control unnecessary.

### Third Modified Example of First Aspect of First Embodiment

FIG. 5 is a schematic view illustrating a state in which plural connectors and a power supply control IC are connected to each other by using a signal line according to a third modified example of the first aspect of the first embodiment. In FIG. 5, elements similar to those in FIG. 2 are designated by like reference numerals.

The structure according to the first aspect of the first embodiment is also applicable to an electronic device 1D of the third modified example shown in FIG. 5.

The electronic device 1D includes a power supply control IC 21, a battery 23 electrically connected to the power supply control IC 21 via a feed line 22, first and second power supply connectors 11D and 12D having different shapes, a feed line 24, and a hollow surface portion 2a. The feed line 24 branches off from the power supply control IC 21 and is electrically connected to the first and second power supply connectors 11D and 12D. The hollow surface portion 2a is provided on an outer surface 2 of the electronic device 1D and holds the first and second power supply connectors 11D and 12D.

In the electronic device 1D, as well as in the electronic devices 1A through 1C, an external device, such as a first power supply cable or a second power supply cable, which is not shown, can be connected only to a selected one of the first and second power supply connectors 11D and 12D.

In the structure according to the third modified example of the first aspect of the first embodiment, only one connector can physically be used, thereby making it possible to mutually exclusively supply power from one of plural power supply connectors having different shapes (such as Micro USB, Mini USB, Type-C USB, dedicated power supply connectors). Even for the same 5V-USB power supply, using different power supply sources produces a potential difference. If different power supply sources are connected to individual power supply connectors, a power leakage may occur. In the third modified example, however, the occurrence of such a power collision can be reduced.

### Second Aspect of First Embodiment

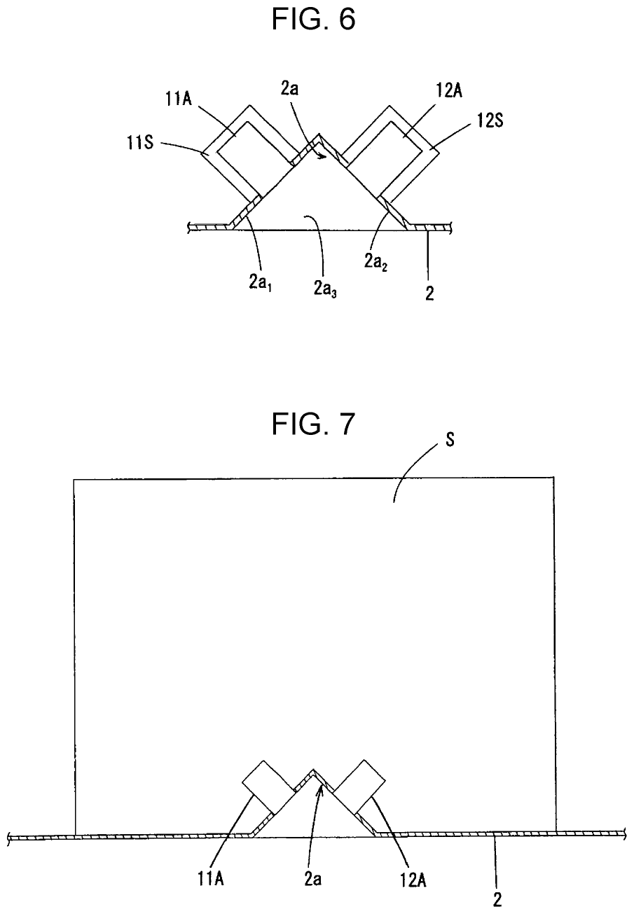

FIG. 6 is a planar sectional view of a structure for implementing the mutually exclusive use of connectors according to a second aspect of the first embodiment. In FIG. 6, elements similar to those in FIG. 1B are designated by like reference numerals.

The structure according to the second aspect of the first embodiment is similar to that of the first aspect of the first embodiment, except that USB connectors 11A and 12A are fixed to mounting substrates 11S and 12S, respectively.

This configuration facilitates wiring work for electrically connecting the USB connectors 11A and 12A to a USB controller (see FIG. 2).

### Third Aspect of First Embodiment

FIG. 7 is a planar sectional view of a structure for implementing the mutually exclusive use of connectors according to a third aspect of the first embodiment. In FIG. 7, elements similar to those in FIG. 1B are designated by like reference numerals.

The structure according to the third aspect of the first embodiment is similar to that of the first aspect of the first embodiment, except that USB connectors 11A and 12A are fixed to a circuit substrate S on which a USB controller (see FIG. 2) is mounted.

This configuration makes wiring work for electrically connecting the USB connectors 11A and 12A to the USB controller (see FIG. 2) unnecessary.

### Fourth Aspect of First Embodiment

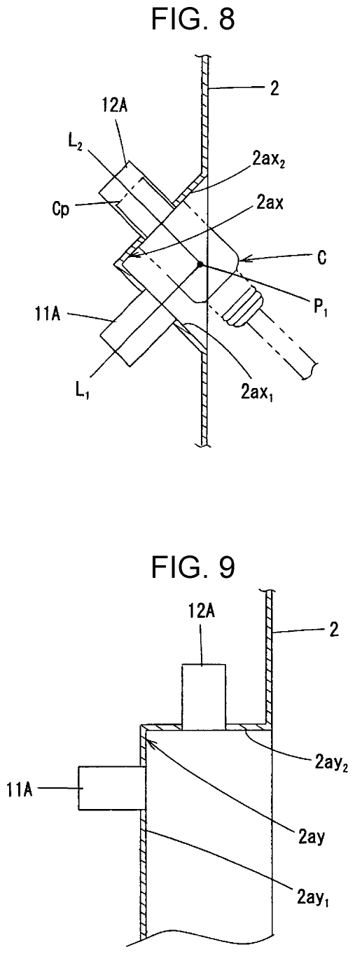

FIG. 8 is a side sectional view of a structure for implementing the mutually exclusive use of connectors according to a fourth aspect of the first embodiment. In FIG. 8, elements similar to those in FIG. 1B are designated by like reference numerals.

In the first through third aspects of the first embodiment, the USB connectors 11A and 12A are horizontally disposed. Alternatively, the USB connectors 11A and 12A may be vertically disposed as shown in FIG. 8.

In this case, a vertically elongated hollow surface portion 2ax is formed on an outer surface 2 of a housing of an electronic device. The USB connectors 11A and 12A are disposed at the hollow surface portion 2ax such that the connecting portions of the USB connectors 11A and 12A are exposed outside through slots formed in two planes 2ax₁ and 2ax₂ of the hollow surface portion. 2ax positioned perpendicularly to each other. The configuration of the other elements is similar to that of the first aspect of the first embodiment.

The structure of the fourth aspect of the first embodiment is suitable for an electronic device having a small horizontal width, for example. In FIG. 8, a plug Cp of a USB cable C is connected to the USB connector 12A (receptacle).

### Modified Example of Fourth Aspect of First Embodiment

FIG. 9 is a side sectional view of a structure for implementing the mutually exclusive use of connectors according to a modified example of the fourth aspect of the first embodiment. In FIG. 9, elements similar to those in FIG. 1B are designated by like reference numerals.

In this modified example, a hollow surface portion 2ay formed in a vertically elongated parallelepiped is provided on an outer surface 2 of a housing of an electronic device. The USB connectors 11A and 12A are disposed such that the connecting portions of the USB connectors 11A and 12A are exposed outside through slots formed in a vertical plane 2ay₁ and a horizontal plane 2ay₂ of the hollow surface portion 2ay positioned perpendicularly to each other.

According to this modified example, it is possible to provide a structure for implementing the mutually exclusive use of connectors by utilizing a right-angled step portion on the outer surface 2 of the housing of an electronic device.

### First Aspect of Second Embodiment

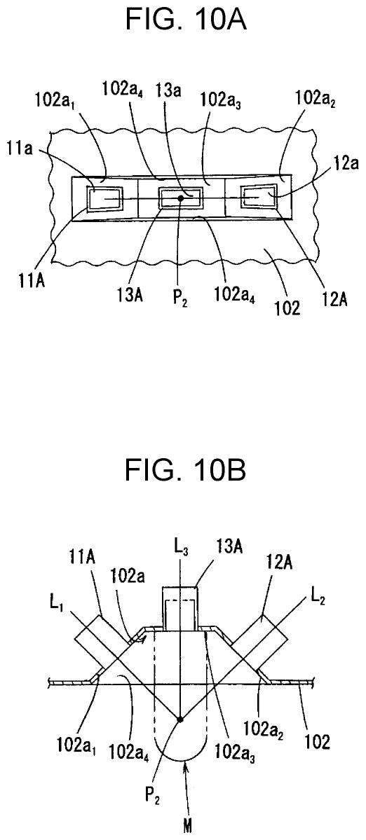

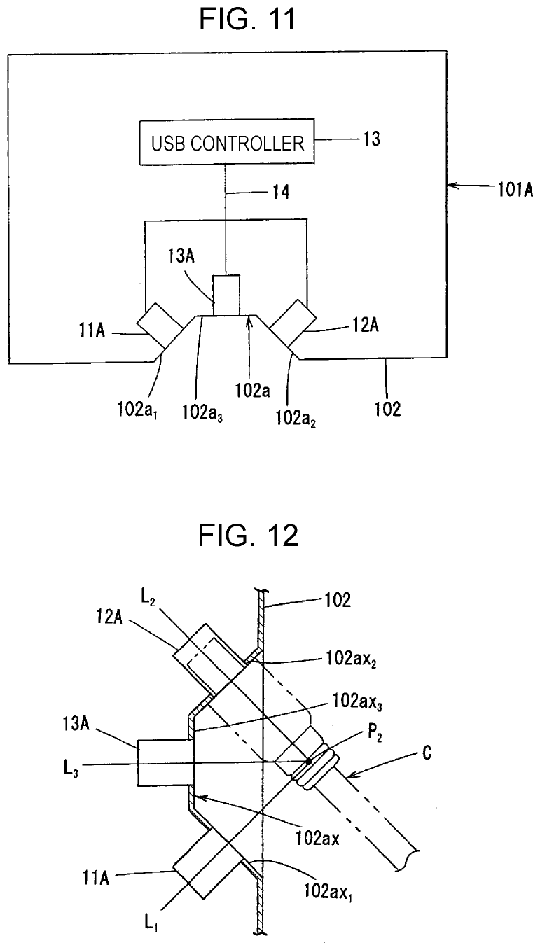

FIGS. 10A and 10B are respectively a front view and a planar sectional view of a structure for implementing the mutually exclusive use of connectors according to a first aspect of a second embodiment. FIG. 11 is a schematic view illustrating a state in which plural USB connectors and a USB controller are connected to each other via a connecting line according to the first aspect of the second embodiment. In FIGS. 10A through 11, elements similar to those in FIGS. 1A through 2 are designated by like reference numerals.

As shown in FIGS. 10A through 11, the structure of the first aspect of the second embodiment includes three connectors arranged side by side on an outer surface 102 of a housing of an electronic device 101A.

In the firs t aspect of the second embodiment, as plural connectors, a Type-A USB connector 11A, a Type-C USB connector 12A, and a Micro-A USB connector 13A are disposed at a horizontally elongated hollow surface portion 102a provided at part of the outer surface (side surface) 102 of the electronic device (host) 101A. In FIGS. 10A and 10B, the USB connectors 11A, 12A, and 13A are shown in a simplified form.

Within the electronic device 101A, a USB controller (controller IC) 13 and a connecting line 14 are disposed. The connecting line 14 branches off from the USB controller 13 and is electrically connected to the USB connectors 11A, 12A, and 13A.

In the structure of the first aspect of the second embodiment, connecting portions 11a, 12a, and 13a of the three USB connectors 11A, 12A, and 13A are located at the same position as the hollow surface portion. 102a of the outer surface 102 of the electronic device 101A.

More specifically, the hollow surface portion 102a has three planes 102a₁, 102a₂, and 102a₃ which join each other at an angle greater than a right angle (about 135° in this example) and a pair of upper and lower trapezoidal opposing planes 102a₄. The opposing planes 102a₄ connect the three planes 102a₁, 102a₂, and 102a₃ and the outer surface 102. The connecting portions 11a, 12a, and 13a of the three USB connectors 11A, 12A, and 13A are respectively located on the three planes 102a₁, 102a₂, and 102a₃ (at the same positions as the planes 102a₄, 102a₂, and 102a₃).

The three planes 102a₁, 102a₂, and 102a₃ are perpendicular to the horizontal direction and have slots through which the connecting portions 11a, 12a, and 13a of the USB connectors 11A, 12A, and 13A are exposed outside.

FIG. 10B shows a state in which the connecting portions 11a, 12a, and 13a of the USB connectors 11A, 12A, and 13A are inserted into and fixed at the slots of the planes 102a₁, 102a₂, and 102a₃. In actuality, however, holders for holding the USB connectors 11A, 12A, and 13A, for example, are fixed around the slots so as to stop the USB connectors 11A, 12A, and 13A from coming out of the slots during the use.

In the structure according to the first aspect of the second embodiment, the three USB connectors 11A, 12A, and 13A are respectively located on radial lines L₁, L₂, and L₃ starting from a predetermined point P₂, and also, the connecting portions 11a, 12a, and 13a of the USB connectors 11A, 12A, and 13A face the predetermined point P₂.

In the structure configured as described above, an external device can be connected only to a selected one of the USB connectors 11A, 12A, and 13A.

That is, as shown in FIG. 10B, when a USB memory M as an external device is connected to the USB connector 13A, it is not physically possible to connect another external device to the USB connector 11A or 12A because the connection path to the USB connectors 11A and 12A are blocked. When an external device is connected to the USB connector 11A or 12A, it is not physically possible to connect other external devices to the remaining USB connectors because the connection paths to these USB connectors are blocked.

The structure according to the first aspect of the second embodiment also achieves advantages similar to those obtained by the first aspect of the first embodiment.

In FIGS. 10A and 10B, the hollow surface portion 102a. is formed in the housing of the electronic device 101A by way of example. Alternatively, the hollow surface portion 102a may separately be formed as a different component, and a unit body in which the three USB connectors 11A, 12A, and 13A are fixed at the hollow surface portion 102a may be inserted into a mounting hole formed in the housing of the electronic device 101A.

### Second Aspect of Second Embodiment

FIG. 12 is a side sectional view of a structure for implementing the mutually exclusive use of connectors according to a second aspect of the second embodiment. In FIG. 12, elements similar to those in FIG. 10B are designated by like reference numerals.

In the first aspect of the second embodiment, the USB connectors 11A, 12A, and 13A are horizontally disposed. Alternatively, the USB connectors 11A, 12A, and 13A may be vertically disposed, as shown in FIG. 12.

In this case, a vertically elongated hollow surface portion 102ax is formed on an outer surface 102 of a housing of an electronic device. The USB connectors 11A, 12A, and 13A are disposed at the hollow surface portion 102ax such that the connecting portions of the USB connectors 11A, 12A, and 13A are exposed outside through slots formed in three planes 102ax₁, 102ax₂, and 102ax₃ of the hollow surface portion 102ax. The planes 102ax₁, 102ax₂, and 102ax₃ join each other at an angle greater than a right angle. The configuration of the other elements is similar to that of the first aspect of the second embodiment.

The structure of the second aspect of the second embodiment is suitable for an electronic device having a small horizontal width, for example. In FIG. 12, a USB cable C is connected to the USB connector 12A.

### Third Embodiment

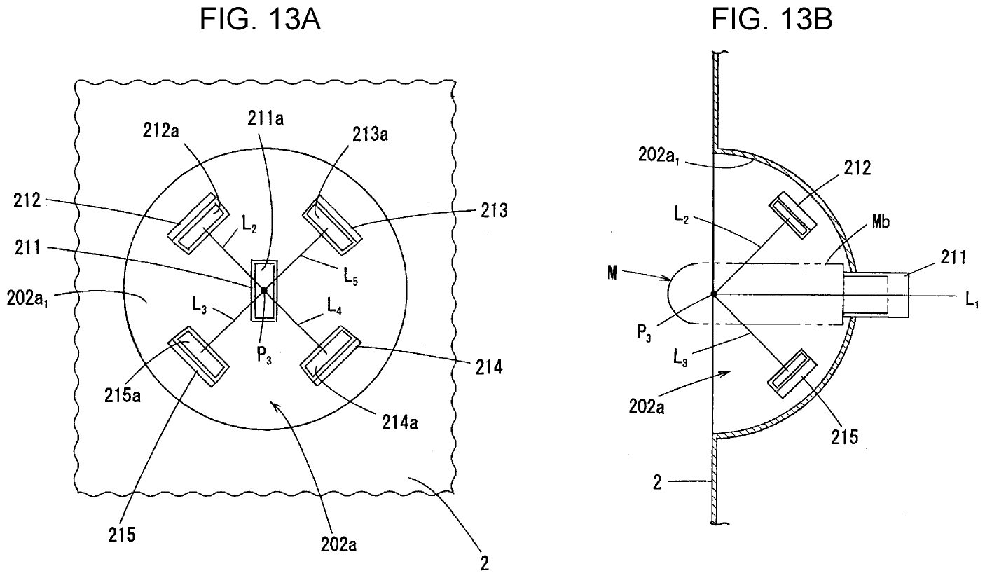

FIGS. 13A and 13E are respectively a front view and a side sectional view of a structure for implementing the mutually exclusive use of connectors according to a third embodiment. In FIGS. 13A and 13E, elements similar to those in FIGS. 1A and 1B are designated by like reference numerals.

As shown in FIGS. 13A and 13B, in the structure according to the third embodiment, a hollow surface portion 202a provided on an outer surface 2 (side surface in this example) of a housing of an electronic device has a curved. surface 202a₁, thereby making it possible to dispose four or more connectors on the curved surface 202a₁.

More specifically, the hollow surface portion 202a has a hemispherical curved surface 202a₁, and five connectors 211, 212, 213, 214, and 215 are disposed on the hemispherical curved surface 202a₁.

In the third embodiment, too, the five connectors 211 through 215 are located on radial lines L₁, L₂, L₃, L₄, and L₅ starting from a predetermined point P₃, and also, the connecting portions 211a, 212a, 213a, 214a, and 215a of the connectors 211 through 215 face the predetermined point P₃. With this arrangement, an external device can be connected only to a selected one of the connectors 211 through 215.

More specifically, in a front view of the hollow surface portion 202a, as shown in FIG. 13A, the connector 211 is disposed at the center of the curved surface 202a₁ and the other four connectors 212 through 215 are disposed around the center of the curved surface 202a₁ at equal intervals at a central angle of 90°.

The configuration of the structure according to the third embodiment makes it possible to increase the area of the hollow surface portion. 202a so that four or more connectors can be disposed. The structure of the third embodiment is thus suitable for disposing DSP connectors having the same interface but being formed in variable shapes.

in the third embodiment, five connectors, such as Type-A, Ayre-C, Micro-A, Micro-B, and Mini-A USB connectors, can be disposed.

In the third embodiment, the connectors 211 through 215 protrude outside from the curved surface 202a₁ so that the housing of an external device, such as a housing Mb of a USB memory M, does not abut against the curved surface 202a₁ when connecting to one of the connectors 211 through 215.

### Fourth Embodiment

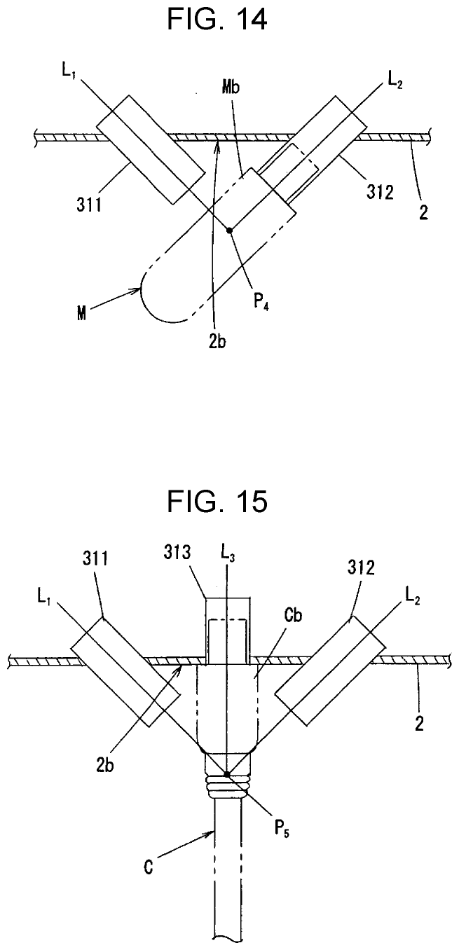

FIG. 14 is a planar sectional view of a structure for implementing the mutually exclusive use of connectors according to a fourth embodiment.

As shown in FIG. 14, a structure for implementing the mutually exclusive use of connectors may be provided at a planar portion 2b of an outer surface 2 of a housing of an electronic device.

In the fourth embodiment, two connectors 311 and. 312 are disposed at the planar portion 2b, The connectors 311 and 312 are respectively located on radial lines L₁ and L₂ starting from a predetermined point F₄, and also, connecting portions of the connectors 311 and 312 face the predetermined point P₄. With this arrangement, an external device can be connected only to a selected one of the connectors 311 and 312.

In the fourth embodiment, the connectors 311 and 312 are fixed to the planar portion 2b such that they tilt (at a tilt angle of about 45° in this example) with respect to the planar portion 2b. The connectors 311 and 312 protrude outside from the planar portion 2b so that the housing of an external device, such as a housing Mb of a USB memory M, does not abut against the planar portion 2b when connecting to one of the connectors 311 and 312.

With the structure of the fourth embodiment, the provision of a hollow surface portion on the outer surface 2 of a housing of an electronic device becomes unnecessary. To reduce the occurrence of breakages of connectors protruding outside due to an accidental collision with someone or something, a rib, which serves as a protective wall, may be provided around the connectors 311 and 312 on the outer surface 2.

### Fifth Embodiment

FIG. 15 is a planar sectional view of a structure for implementing the mutually exclusive use of connectors according to a fifth embodiment. In FIG. 15, elements similar to those in FIG. 14 are designated by like reference numerals.

As shown in FIG. 15, in the structure according to the fifth embodiment, three connectors 311, 312 and 313 are disposed at a planar portion 2b of an outer surface 2 of a housing of an electronic device.

The connectors 311, 312, and 313 are respectively located on radial lines L₁, L₂, and L₃ starting from a predetermined point P₅, and also, connecting portions of the connectors 311 through 313 face the predetermined point P₅. With this arrangement, an external device can be connected only to a selected one of the connectors 311 through 313.

In the fifth embodiment, the connectors 311 and 312 are fixed to the planar portion 2b such that they tilt (at a tilt angle of about 45° in this example) with respect to the planar portion 2b, while the remaining connector 313 is vertically fixed to the planar portion 2b between the connectors 311 and 312.

The connectors 311 and 312 protrude outside from the planar portion 2b so that the housing of an external device, such as a housing Cb of a USB cable C, does not abut against the planar portion 2b when connecting to one of the connectors 311 and 312. In contrast, the connecting portion of the connector 313 at the center is flush with the planar portion 2b because the housing of an external connector woes not abut against the planar portion 2b.

As in the fourth embodiment, with the structure of the fifth embodiment, the provision of a hollow surface portion on the outer surface 2 of the housing of an electronic device becomes unnecessary. To reduce the occurrence of breakages of connectors protruding outside due to an accidental collision with someone or something, a rib, which serves as a protective wall, may be provided around the connectors 311 through 313 on the outer surface 2.

### Sixth Embodiment

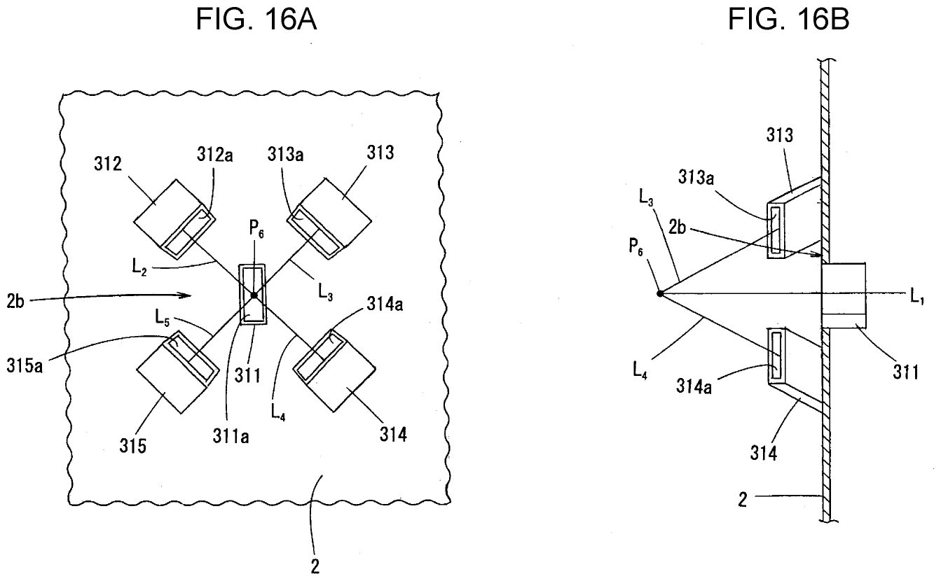

FIGS. 16A and 16B are respectively a front view and a side sectional view of a structure for implementing the mutually exclusive use of connectors according to a sixth embodiment. In FIGS. 16A and 16B, elements similar to those in FIG. 14 are designated by like reference numerals.

As shown in FIGS. 16A and 16B, in the structure according to the sixth embodiment, five connectors 311, 312, 313, 314, and 315 are disposed at a planar portion 2b of an outer surface 2 of a housing of an electronic device.

The five connectors 311 through 315 are respectively located on radial lines L₁, L₂, L₃, L₄, and L₅ starting from a predetermined point P₆, and also, connecting portions 311a. through 315a of the connectors 311 through 315 face the predetermined point P₆. With this arrangement, an external device can be connected only to a selected one of the connectors 311 through 315.

In the sixth embodiment, the connector 311 is vertically fixed to the planar portion 2b, while the connectors 312 through 315 are fixed to the planar portion 2b around the connector 311 such that they tilt (at a tilt angle of about 45° in this example) with respect to the planar portion 2b and such that they are disposed at equal intervals at a central angle of 90° in a front view of the structure (FIG. 16A).

The connectors 312 through 315 protrude outside from the planar portion 2b so that an external device (not shown) does not abut against the planar portion 2b when connecting to one of the connectors 312 through 315. In contrast, the connecting portion of the connector 311 at the center is flush with the planar portion 2b.

As in the fourth and fifth embodiments, with the structure of the sixth embodiment, the provision of a hollow surface portion on the outer surface 2 of the housing of an electronic device becomes unnecessary. To reduce the occurrence of breakages of connectors protruding outside due to an accidental collision with someone or something, a rib, which serves as a protective wall, may be provided around the connectors 311 through 315 on the outer surface 2.

### Other Embodiments

1. The second and third aspects of the first embodiment (FIGS. 6 and 7) may be applicable to the fourth aspect of the first embodiment and the modified example thereof (FIGS. 8 and 9) and the first and second aspects of the second embodiment (FIGS. 10A, 10B, and 12).

2. The second as t of the first embodiment (FIG. 6) may be applicable to the third through sixth embodiments (FIGS. 13A through 16B).

3. In the first aspect of the second embodiment (FIGS. 10A and 10B), a hollow surface portion having a trapezoidal surface has been discussed by way of example. Alternatively, a hollow surface portion having a semicircular or semiellptical surface may be provided. In this case, too, three connectors may be disposed at the hollow surface portion.

4. In the third embodiment (FIGS. 13A and 13B) and the sixth embodiment (FIGS. 16A and 16B), any one to three of the five connectors may be omitted, thereby resulting in a structure for implementing the mutually exclusive use of two to four connectors.

5. In the third embodiment. (FIGS. 13A and 13B), the hemispherical hollow surface portion has been discussed by way of example. However, the hollow surface portion may be formed in another shape other than a hemisphere. For example, a square-frustum hollow surface portion having a square plane and four trapezoidal planes disposed around the square plane may be formed, and connectors may be formed on the individual planes. With this arrangement, too, plural connectors are disposed on radial lines starting from a predetermined point and the connecting portions of the connectors face the predetermined point, so that an external device can be connected only to a selected one of the plural connectors.

With this configuration, the body of an external device, such as the body of a USB memory, does not abut against a plane of the hollow surface portion when connecting to a connector. The connecting portions of the connectors can thus become flush with the planes of the hollow surface portion.

The hollow surface portion may be formed in a shape other than a square frustum. The hollow surface portion may be formed in a triangular frustum, a pentagonal frustum, or a hexagonal frustum, for example.

Instead of being formed in a frustum, the hollow surface portion may alternatively be formed in a regular triangular pyramid, a regular square pyramid, a regular pentagonal pyramid, or a regular hexagonal pyramid, for example.

6. In the fourth through sixth embodiments (FIGS. 14 through 16B), a structure for implementing the mutually exclusive use of connectors is provided on the flat outer surface (planar portion) of an electronic device. Alternatively, a hollow portion having a flat bottom (planar portion) may be formed on an outer surface of a housing of an electronic device, and a structure for implementing the mutually exclusive use of connectors, such as those in the fourth through sixth embodiments, may be provided on the bottom surface of the hollow portion. With this configuration, even if part of a connector protrudes from the bottom surface of the hollow portion, it is less likely that someone or something will accidentally hit the connector, thereby reducing breakages of the connectors.

### Conclusions

A structure for mutually exclusive use of connectors according to an aspect of the disclosure includes plural connectors. The plural connectors are disposed adjacent to each other on an outer surface of a housing of an electronic device. Each of the plural connectors has a connecting portion connectable to an external device. The plural connectors are located on radial lines starting from a predetermined point and the connecting portion of each of the plural connectors faces the predetermined point, so that an external device is connectable only to a selected one of the plural connectors.

The above-described structure may be formed in one of the following configurations or in some of the following configurations suitably combined with each other.

(1) The plural connectors may be disposed at a hollow surface portion on the outer surface of the housing of the electronic device. This configuration makes it possible to dispose the connecting portions of the connectors at positions at which they are pulled back from the outer surface of the housing of the electronic device.

More specifically, the structure may be configured in the following manner.
(A) The hollow surface portion may have two planes which join each other at a right angle, and two connectors may be disposed on the two planes.
(B) The hollow surface portion may have three planes which join each other at an angle greater than a right angle, and three connectors may be disposed on the three planes.
(C) The hollow surface portion may have a curved surface, and the plural connectors may be disposed on the curved surface. The configuration (C) makes it possible to dispose two or more connectors on the curved surface.

(2) The plural connectors may be disposed at a planar portion on the outer surface of the housing of the electronic device. The plural connectors may be located at positions at which the connecting portions protrude outside from the planar portion.

With this configuration, without forming a hollow surface portion on the outer surface of the housing of the electronic device, the plural connectors can be disposed on the planar portion such that they are located on radial lines starting from a predetermined point and such that the connecting portion of each of the plural connectors faces the predetermined point.

(3) The plural connectors may include a Type-A USB connector and a Type-C USB connector, or a wired LAN connector and a wireless LAN connector, or first and second power supply connectors having different shapes.

With this configuration, it is possible to implement an electronic device that includes USB connectors including a Type-A USB connector and a Type-C USB connector having the same interface but being formed in different shapes, or LAN connectors including a wired LAN connector and a wireless LAN connector having different interfaces, or power supply connectors including first and second power supply connectors being formed in different shapes.

The present disclosure contains subject matter related to that disclosed in Japanese Priority Patent Application JP 2018-092258 filed in the Japan Patent Office on May 11, 2018, the entire contents of which are hereby incorporated by reference.

The present disclosure is not restricted to the above-described embodiments. The embodiments are to be considered in all respects as illustrative and not restrictive.

It should be understood by those skilled in the art that various mddifications, combinations, sub-combinations and alterations may occur depending on design requirements and other factors insofar as they are within the scope of the appended claims or the equivalents thereof. The scope of the disclosure is described by the appended claims and all changes which come within the meaning and range of equivalency of the claims are intended to be embraced therein.

What is claimed is:

1. A structure for mutually exclusive use of connectors, comprising:
a plurality of connectors that are disposed adjacent to each other on an outer surface of a housing of as electronic device, wherein
each of the plurality of connectors has a connecting portion which is connectable to an external device, and
the plurality of connectors are located on radial lines starting from a predetermined point and the connecting portion of each of the plurality of connectors faces the predetermined point, so that an external device is connectable only to a selected one of the plurality of connectors.

2. The structure according to claim 1, wherein the plurality of connectors are disposed at a hollow surface portion on the outer surface of the housing of the electronic device.

3. The structure according to claim 2, wherein:
the hollow surface portion has two planes which join each other at a right angle; and
the plurality of connectors are two connectors, and the two connectors are disposed on the two planes.

4. The structure according to claim 2, wherein:
the hollow surface portion has three planes which join each other at an angle greater than a right angle; and
the plurality of connectors are three connectors, and the three connectors are disposed on the three planes.

5. The structure according to claim 2, wherein:
the hollow surface portion has a curved surface; and
the plurality of connectors are disposed on the curved surface.

6. The structure according to claim 1, wherein:
the plurality of connectors are disposed at a planar portion on the outer surface of the housing of the electronic device; and
the plurality of connectors are located at positions at which the connecting portions protrude outside from the planar portion.

7. The structure according to claim 1, wherein the plurality of connectors include a Type-A universal serial bus connector and a Type-C universal serial bus connector, or a wired local area network connector and a wireless local area network connector, or first and second power supply connectors having different shapes.
